(19) United States
(12) Patent Application Publication
(10) Pub. No.: US 2017/0329344 A1
(43) Pub. Date: Nov. 16, 2017

(54) METHOD FOR ROBOTIC LOCALIZATION

(71) Applicant: KING FAHD UNIVERSITY OF PETROLEUM AND MINERALS, DHAHRAN (SA)

(72) Inventors: UTHMAN ABDUL-RAHMAN BAROUDI, DHAHRAN (SA); MOHAMMED MAHMOOD AL-SHABOTI, DHAHRAN (SA)

(21) Appl. No.: 15/152,498

(22) Filed: May 11, 2016

(51) Int. Cl. G05D 1/02

(52) U.S. Cl. CPC G05D 1/0246

(57) ABSTRACT

The method for robotic localization is a color-based method for determining the coordinates of a mobile robot. The mobile robot is initially positioned in one colored block of a colored grid imprinted on a surface, which is divided into a plurality of colored blocks extending along rows in a first direction and columns in a second direction. A degree of contrast of a first color respectively varies in each colored block in the rows extending in the first direction, and a degree of contrast of the second color respectively varies in each colored block in the rows extending in the second direction. A color sensor measures the degrees of contrast of the first color and the second color, and a localization system translates the measured degrees of contrast of the first color and the second color into respective positional coordinates in the first and second directions.

### BACKGROUND OF THE INVENTION

### 1. Field of the Invention

The present invention relates to location determination for autonomous devices, such as mobile robots and the like, and particularly to a method for determining the coordinates of a mobile robot or the like based on color sensing.

### 2. Description of the Related Art

Autonomous vehicles, such as mobile robots, are frequently required to navigate in a working environment. Such navigation involves planning a path, controlling the vehicle along the path, avoiding obstacles, and fine positioning the mobile robot with respect to target objects (a process commonly referred to as “docking”). In order to perform mobile robot navigation, the mobile robot must be provided with information regarding the precise position and orientation of the mobile robot relative to a fixed coordinate system. Such information assists the mobile robot in planning and following a route, in docking maneuvers, and in coordinating with other systems, including other mobile robots.

Commonly-used methods for providing a robot with such information include dead reckoning, inertial navigation, and satellite-based positioning. In traditional dead reckoning and inertial navigation systems, the mobile robot keeps track of its various movements and calculates its position and orientation accordingly. However, inaccuracies in tracking or calculation are cumulative, so that a series of small errors can lead to substantial mistakes, particularly in docking. Satellite-based positioning requires a clear communications path to a satellite and also does not provide location information with the precision required for docking maneuvers.

More complex methods involve placing specially designed three-dimensional objects at known positions in the working environment, which are then used as landmarks. These landmarks are sensed by a vision system carried by the mobile robot. The visual information about the landmarks is processed by the robot, enabling it to detect and recognize the various landmarks, and to determine its own position with respect to them. However, if the working environment is cluttered or unevenly lit, or if the landmarks are partially occluded, errors may occur in detecting or recognizing the landmarks, resulting in errors in the position determined for the mobile robot. Additionally, the processing in typical landmark systems can be prohibitive, as such systems require pattern recognition which is typically performed by neural networks and the like. Thus, a method for robotic localization solving the aforementioned problems is desired.

### SUMMARY OF THE INVENTION

The method for robotic localization is a color-based method for determining the coordinates of a mobile robot. The mobile robot is initially positioned in one colored block of a colored grid imprinted on a surface (such as the floor, ground or the like). The colored grid is divided into a plurality of colored blocks extending along rows in a first direction and columns in a second direction. For example, the colored grid may be divided into a rectangular Cartesian grid having square or rectangular-shaped blocks extending along both the x-axis and the y-axis. Each of the colored blocks has a total color associated therewith, with the total color being a combination of a first color and a second color. A degree of contrast of the first color respectively varies in each colored block in the rows extending in the first direction, and a degree of contrast of the second color respectively varies in each colored block in the rows extending in the second direction. As an example, the first color may be red and the second color may be green. The degree of contrast of red (or the “amount” of red when visually observed) may increase along the x-axis, from colored block to colored block, and the degree of contrast of green similarly increases along the y-axis, from colored block to colored block.

The mobile robot has an on-board color sensor for optically scanning the colored block in which the mobile robot is initially positioned. The on-board color sensor measures the degree of contrast of the first color and the degree of contrast of the second color thereof An on-board localization system then translates the measured degree of contrast of the first color and the measured degree of contrast of the second color into respective positional coordinates in the first direction and the second direction. In this way, the mobile robot's location is defined by the positional coordinates in the first direction and the second direction.

In use, the method for robotic localization may be used for directing the mobile robot towards a selected target. A set of target coordinates may be transmitted to the mobile robot by any suitable method (wirelessly, through direct interface, etc.), and with the measured and translated positional coordinates, the mobile robot may then calculate the straight line distance between the positional coordinates of the mobile robot and the set of target coordinates. The mobile robot is then angularly oriented towards the set of target coordinates based on a pre-determined initial angular orientation of the mobile robot. Movement of the mobile robot is then actuated, causing the mobile robot to travel the calculated straight line distance between the positional coordinates and the set of target coordinates.

These and other features of the present invention will become readily apparent upon further review of the following specification.

### BRIEF DESCRIPTION OF THE DRAWINGS

FIG. 1 is a plan view of a mobile robot implementing a method for robotic localization according to the present invention.

FIG. 2 is a plan view of a mobile robot implementing the method for robotic localization, particularly illustrating obstacle avoidance.

FIG. 3 is a block diagram illustrating components of an on-board system for implementing the method for robotic localization.

Similar reference characters denote corresponding features consistently throughout the attached drawings.

### DETAILED DESCRIPTION OF THE PREFERRED EMBODIMENTS

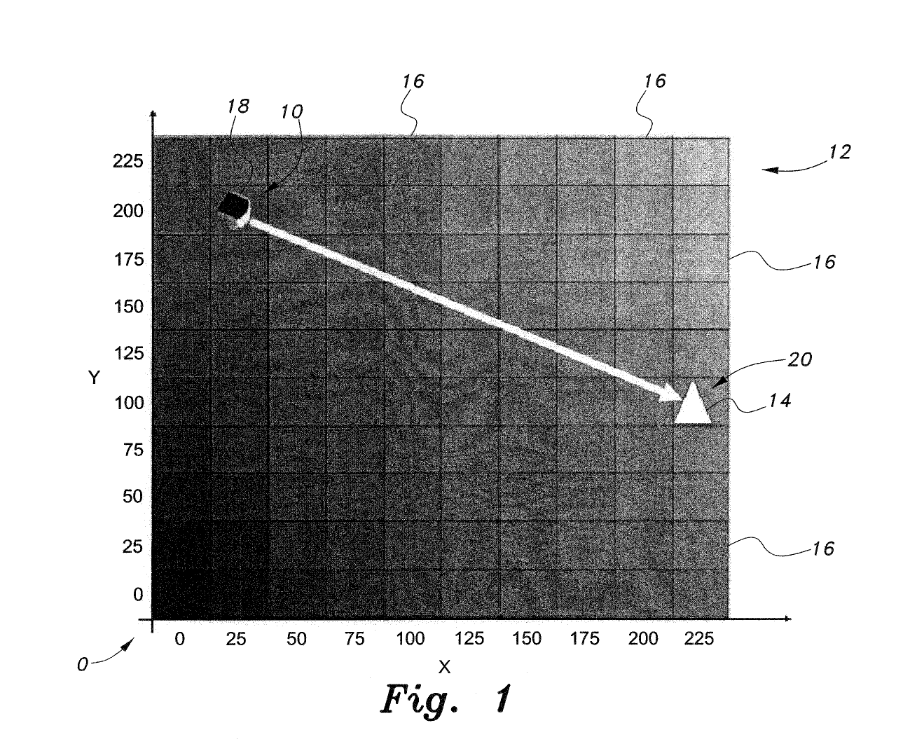

The method for robotic localization includes on-board determination of the coordinates of a mobile robot based on a colored grid. As shown in FIG. 1, a mobile robot 10 is initially positioned on a colored grid 12 imprinted on a surface (such as the floor, ground or the like). The colored grid 12 is divided into a plurality of colored blocks 16 extending along rows in a first direction and columns in a second direction. The colors for the colored blocks 16 can be red, green, and/or blue, for example. The colored grid 12 may be divided into a rectangular Cartesian grid having square or rectangular-shaped blocks 16 extending along both the x-axis and the y-axis. As an example, 100 colored blocks 16 may be arranged in a square colored grid 12 in a ten block by ten block arrangement, as in the example of FIG. 1. For a small room, as an example, a 2.5 m×2.5 m floor space may be divided into 100 square blocks, each having dimensions of 25 cm×25 cm. This would provide the mobile robot localization with a resolution of 25 cm. It should be understood that colored grid 12 is shown in FIG. 1 for exemplary purposes only, and that any desired size or relative dimensions may be used in the formation of grid 12.

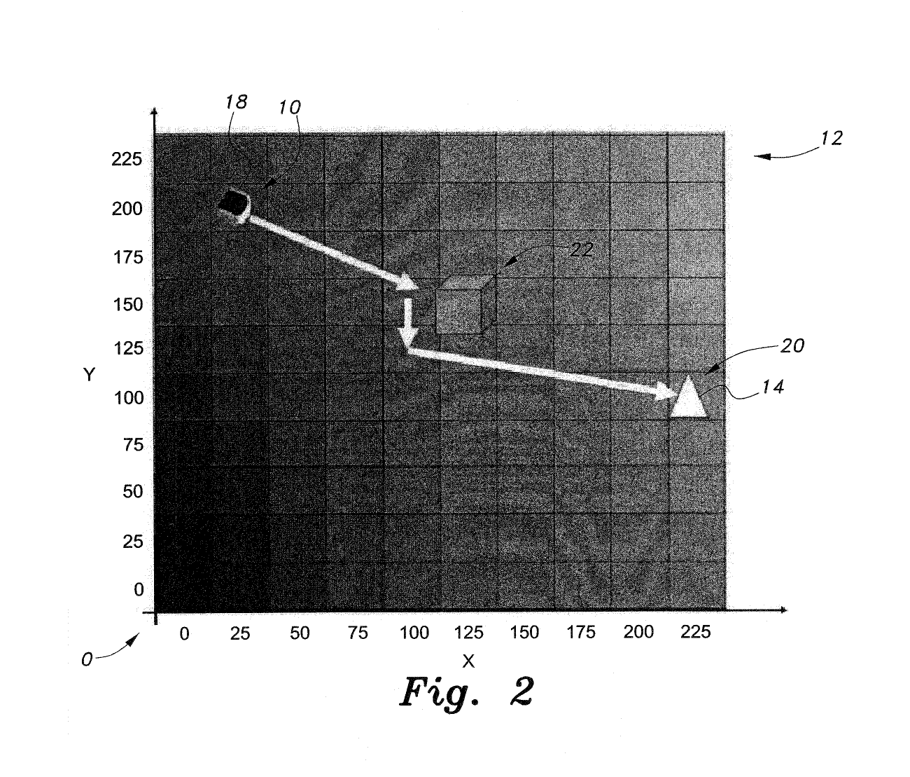

According to an embodiment, each of the colored blocks 16 can have a total color associated therewith. For example, the total color can be a first color, a second color, and/or a combination of a first color and a second color. A degree of intensity or contrast of the first color respectively varies in each colored block 16 in the rows extending in the first direction, and a degree of intensity or contrast of the second color respectively varies in each colored block 16 in the rows extending in the second direction. As an example, the first color may be red and the second color may be green. The degree of contrast of red (or the “amount” of red when visually observed) may increase along the x-axis, from colored block to colored block, and the degree of contrast of green similarly increases along the y-axis, from colored block to colored block. It should be understood that the grey-scale shading shown in FIGS. 1 and 2 represents variation of the first and second colors in each colored block 16.

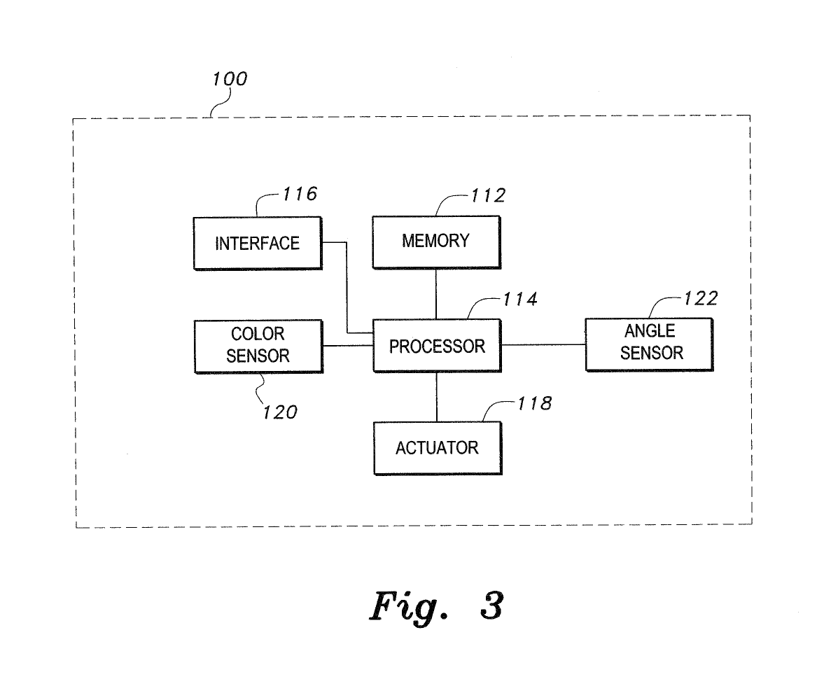

The mobile robot 10 can have an on-board color sensor 120 for optically scanning the colored block in which the mobile robot is initially positioned. In the example of FIG. 1, the initial colored block is indicated as 18. The on-board color sensor 120 measures the degree of contrast of the first color and the degree of contrast of the second color of initial block 18. As shown in FIG. 3, the on-board color sensor 120 is part of an on-board localization system 100 which translates the measured degree of contrast of the first color and the measured degree of contrast of the second color into respective positional coordinates in the first direction and the second direction.

As described above, the example of FIG. 1 uses a 2.5 m×2.5 m floor space divided into 100 square blocks, each having dimensions of 25 cm×25 cm, thus giving the mobile robot 10 localization with a resolution of 25 cm. In this example, each block 16 also represents a contrast resolution which varies in increments of 25 degrees of contrast. In the example of FIG. 1, the mobile robot is initially located in block 18. Color sensor 120 may measure a degree of red contrast (degree of contrast of the first color in this example) of 25 and may measure a degree of green contrast (degree of contrast of the second color in this example) of 200. A translational map of color degree and corresponding Cartesian coordinates is stored in memory 112. In the example of FIG. 1, as indicated by the legends on the x-axis and y-axis of grid 12, the measured red and green contrast degrees correspond to an x-axis position of 25 cm (from the origin O) and a y-axis position (from origin O) of 200 cm. In this way, the mobile robot's location is defined by the positional coordinates in the first direction and the second direction, based on the known mapping of the correspondence between first and second color contrast degrees with first and second Cartesian positions, which is stored in on-board memory 112. Alternatively, the positional coordinates may be computed by a stored translation equation which transforms the input block's color data into the associated Cartesian coordinates. As an example, if the first color contrast is measured as c₁ and the second color contrast is measured as c₂, then corresponding Cartesian coordinates could be calculated as (x, y)=(k₁c₁, k₂c₂), where k₁ and k₂ are known constants. It should be understood that any suitable type of transformation between the detected color contrasts and the output Cartesian coordinates may be utilized.

It should be understood that the calculations may be performed by any suitable type of on-board computer system, such as that diagrammatically shown in FIG. 3. Data may entered into system 100 via any suitable type of user interface 116, which may be a wireless interface, a wired interface, etc., and may be stored in memory 112, which may be any suitable type of computer readable and programmable memory and is preferably a non-transitory, computer readable storage medium. Calculations are performed by processor 114, which may be any suitable type of computer processor. As will be discussed in further detail below, an angular orientation sensor 122, such as a gyro sensor or the like, provides data regarding the angular orientation of mobile robot 10 on grid 12, and processor 114 is in communication with an actuator 118 for driving movement of the mobile robot 10 under command of processor 114.

Processor 114 may be associated with, or incorporated into, any suitable type of computing device, for example, a personal computer or a programmable logic controller. The actuator 118, the interface 116, the color sensor 120, the angle sensor 112, the processor 114, the memory 112 and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

It should be understood that color sensor 120 may be any suitable type of color sensor for determining the colors associated with a particular colored block 16. Examples of such color sensor are shown in U.S. Pat. No. 8,972,061 B2 and U.S. Patent Application Publication No. US 2011/0026833 A1, each of which is hereby incorporated by reference in its entirety. Similarly, it should be understood that any suitable type of angular orientation sensor 122, such as a gyroscopic sensor or the like, may be used for determining the angular orientation of mobile robot 10 with regard to the colored grid 12. Further, it should be understood that the present method may be used with any suitable type of mobile robot and its associated actuators, such as those shown in U.S. Pat. No. 8,972,061 B2 and U.S. Patent Application Publication No. US 2011/0026833 A1, for example. Further, it should be understood that any suitable method of mapping and translating visual information into positional information may be utilized. An example of such a system is shown in U.S. Pat. No. 5,525,883, which is hereby incorporated by reference in its entirety.

In use, the method for robotic localization may be used for directing the mobile robot 10 towards a selected target, such as exemplary target 14 in colored block 20 in FIG. 1. A set of target coordinates are transmitted or otherwise input to the mobile robot 10 by through interface 116. In the example of FIG. 1, colored block 20 has an x-axis position of 225 cm and a y-axis position of 100 cm. In this example, as described above, the on-board computer system 100 has already determined the position of the mobile robot 10 in block 18 to have an x-axis position of 25 cm and a y-axis position of 200 cm. Processor 114 may easily calculate the straight line distance between the positional coordinates of the mobile robot 10 and the set of target coordinates. For a set of positional coordinates for mobile robot 10, (xᵣ, yᵣ), and a set of target coordinates, (xₜ, yₜ), the straight line distance, D, is given by:

D=\sqrt{(xᵣ−xₜ)²+(yᵣ−yₜ)²}. (1)

The direction, θ, in which the mobile robot 10 must travel along distance D, with respect to the x-axis of grid 12, is given by:

$$θ = {tan}^{- 1} ( \frac{{y}_{t} - {y}_{r}}{{x}_{t} - {x}_{r}} ) . \qquad ( 2 )$$

Processor 114 transmits instructions to actuator 118 to angularly orient the mobile robot 10 along angle θ and then to travel the calculated straight line distance D between the positional coordinates and the set of target coordinates.

Mobile robot 10 may also include the ability to detect and avoid obstacles. It should be understood that any suitable type of obstacle avoidance system may be used. Examples of such obstacle avoidance systems for mobile robots are shown in U.S. Pat. Nos. 9,020,641 B2 and 9,002,511 B1, each of which is hereby incorporated by reference in its entirety. In the example of FIG. 2, an obstacle 22 is placed in the path between mobile robot 10 and the target 20. When mobile robot 10 encounters obstacle 22 (located at an x-axis position of 100 cm and a y-axis position of 125 cm in the example of FIG. 2), mobile robot 10 avoids colliding with obstacle 22 and, once clear, optically scans its position on grid 12, re-calculates the angle and distance between its new position and target 20, and then continues on the new route to read target block 14.

It is to be understood that the present invention is not limited to the embodiments described above, but encompasses any and all embodiments within the scope of the following claims.

We claim:

1. A method for robotic localization, comprising:
positioning a mobile robot on a surface, the surface having a colored grid imprinted thereon, wherein the colored grid is divided into a plurality of colored blocks extending along rows in a first direction and columns in a second direction, each said colored block having a total color associated therewith, the total color being a combination of a first color and a second color, a degree of contrast of the first color respectively varying in each said colored block in the rows extending in the first direction, and a degree of contrast of the second color respectively varying in each said colored block in the rows extending in the second direction, the mobile robot being initially positioned in one of the plurality of colored blocks;
optically scanning the colored block in which the mobile robot is initially positioned to measure the degree of contrast of the first color and the degree of contrast of the second color thereof; and
translating the measured degree of contrast of the first color and the measured degree of contrast of the second color into respective positional coordinates in the first direction and the second direction, the mobile robot's location being defined by the positional coordinates in the first direction and the second direction.

2. The method for robotic localization as recited in claim 1, further comprising the step of transmitting a set of target coordinates to the mobile robot.

3. The method for robotic localization as recited in claim 2, further comprising the step of calculating a straight line distance between the positional coordinates of the mobile robot and the set of target coordinates.

4. The method for robotic localization as recited in claim 3, further comprising the step of angularly orienting the mobile robot towards the set of target coordinates based on a pre-determined initial angular orientation of the mobile robot.

5. The method for robotic localization as recited in claim 4, further comprising the step of actuating movement of the mobile robot from the positional coordinates such that the mobile robot travels the calculated straight line distance between the positional coordinates and the set of target coordinates.
